(19) United States
(12) Patent Application Publication
(10) Pub. No.: US 2016/0335765 A1
(43) Pub. Date: Nov. 17, 2016

(54) Three dimensional modeling of health data

(71) Applicant: Justus W. Harris, Oakland, CA (US)

(72) Inventor: Justus W. Harris, Oakland, CA (US)

(21) Appl. No.: 15/149,842

(22) Filed: May 9, 2016

Related U.S. Application Data
(60) Provisional application No. 62/160,273, filed on May 12, 2015.
(60) Provisional application No. 62/316,349, filed on Mar. 31, 2016.

(51) Int. Cl. G06T 7/00; G06T 7/60; G06K 9/52; G06F 17/30; G06T 15/00

(52) U.S. Cl. CPC G06T 7/0012; G06F 17/30554; G06T 15/00; G06K 9/52; G06T 7/60; G06T 2207/30108; G06T 2207/30004

(57) ABSTRACT

The present invention provides a method for visualizing health-data. The method involving collecting a plurality of measurements of at least one health-affecting variable; calculating an average value or instantiation of the health variable over the period of time; and building a three-dimensional object having using visual and/or tactile features that convey the averaged value or instantiation of the at least one health-affecting variable to an observer over a given time period.

### CROSS-REFERENCE TO RELATED APPLICATION

This application claims priority under 35 U.S.C. §119 to U.S. Provisional Application Ser. No. 62/160,273 entitled Device and Method for Tactile and Visual Representation of Data, filed May 12, 2015; and to U.S. Provisional Application Ser. No. 62/316,349 entitled Device and Method for Tactile and Visual Representation of Data, filed Mar. 31, 2016 the disclosures of which are incorporated in their entirety by these references.

### FIELD

This invention relates to the visual or tactile representation of data, and more particularly, this invention relates to a method for producing three-dimensional representations of data, including medical data.

### BACKGROUND

The health and emotions of every person are affected by millions of variables, including the food consumed, the environment (e.g., sights, sounds, smells), and the amount of exercise. There are so many variables that typically, only a small subset of the variables affecting the health of a person is scrutinized over a person's lifetime

Of this small subset of variables, many (blood pressure, heart rate or pulse, skin appearance, ear, nose, and throat exams) are only scrutinized or examined during annual checkups. Furthermore, many health-affecting variables (e.g., cholesterol) are scrutinized even less than once a year. Some health-affecting variables are only scrutinized when a person is in acute distress. For example, blood levels of certain enzymes are only measured where a person is having or is expected to have had a heart attack.

There is a yet smaller subset of health-affecting variables that is scrutinized on an ongoing basis. And, where a person is actively monitoring a particular health-affecting variable, it is usually because of the presence of a chronic condition or concern that compels or necessitates active monitoring of a particular health-affecting variable.

For example, people with a chronic disease, such as diabetes, actively monitor blood glucose (“BG”) levels. People concerned about their physical fitness often actively monitor health-affecting variables such as weight, caloric intake, distance walked or steps taken per day, and time spent sleeping per day.

Where a particular health-affecting variable or set of variables is actively monitored, data points representing one sampling of a health-affecting variable are normally viewed as a single numerical or graphical value (this is widely varying i.e. insulin pump reports, .pdfs, and printouts) that may represent a set time period. (Diabetes data is somewhat different, for example, if using a Continuous Glucose Monitor (CGM), which produces an approximation of blood glucose every 5 minutes, they can check the display of their CGM which displays one number. yet the trend of there blood glucose is important and that number outside of the context of their health over the rest of the day, week, and month is hard to discern meaning from.

### SUMMARY

Even when health data is recorded, comprehending large amounts of this data takes a high degree of analytical skill which is not practical or dynamic enough for most people to draw insights from their health data over time. For example, where there is a reason to actively monitor a particular health-affecting variable, there is often more to be learned from looking at a time-averaged value of a health-affecting variable. For example, a person trying to keep up an active lifestyle would glean more important information from the average value of distance walked per day over the course of a month than viewing a single data point for distance walked over a single day. Additionally, the percentage of time within a certain target range is another key factor in diseases like diabetes. Where the amount of time one spends in range i.e. not above and below their range, can also tell more about their health than an average that may exist in range but represents extremes.

Additionally one may find more value in looking at the amount of steps taken during a specific time period such as a morning commute that they are trying to complete by foot as often as possible.

People with certain chronic conditions requiring active monitoring are best served by scrutinizing both the average of a particular health-affecting variable over time, the percentage of time in a target range such as blood glucose, and the individual data points that make up that average such as a very low blood sugar, which is significant even if it does not greatly effect the average because of the physical dangers. The general rubric for how well a diabetic is dealing with their disease is the average of the patient's blood glucose values over time and time that they spend in a their target range but can also include instances where a person can participate in a desired activity such as running or high endurance sports without extreme blood glucose fluctuations.

Most methods of monitoring health-affecting variables produce either an average of a health-affecting variable over a period of time or a single data point taken once. Blood work results are an example of such monitoring methods. Typical blood work results often contain either single data points, such as cholesterol levels or an average over time, such as the average glucose blood levels during a three month period via an Hba1c test.

Some health-affecting variable monitoring methods allow for viewing averages over periods of time, specific activity goals often dealing with a percentage calculation such as standing 50% of the day, and individual data points. Many fitness tracking software applications do this by displaying a single data point representing the number of steps taken on a particular day and another data point representing an average steps taken per day.

Conventional monitoring methods of health-affecting variables that present a user with single data points, averages over time, time in target ranges or all of the above, all share the same disadvantage: they all present results in the form of numbers, graphs, or both. For many, data tables and out of reference range values are difficult to decipher. Beyond an indication that the results are good, bad, or abnormal, data on paper can be difficult to conceptualize. Additionally comprehending large data sets with advanced concepts such as standard deviations can be difficult forms relying on numerical information for those with low numeracy skills. Furthermore, variables on paper or a screen have little staying power in the average person's mind as they often show a month spread across multiple sheets as a graph and must synthesized as a whole. Additionally units of measurement for blood glucose can vary from country to country where the same BG for someone with diabetes can be represented as 6.7 mmol/L or 120 mg/dl. Thus, conventional monitoring techniques can make it difficult to personalize monitoring results.

A need exists in the art for a method of monitoring health, and emotion affecting variables that gives the user individualized, physical, and/or tactile access to data regarding their health. A need also exists for a tactile or concrete (e.g. something tangible such as an object) media to express these variables so as to enable the user to recollect his or her emotional or physical state existing at the time the data were harvested.

For instance, patients suffering from diabetes are not well served by only seeing the average value of their blood glucose value over time if they cannot see within large peaks or valleys represented by individual blood glucose readings that can have devastating, acute effects. These outliers are extraordinarily important to identify and analyze, but are often hidden in a single average value that may falsely suggest to the patient that they are doing well.

Another object of the invention is to provide a data visualization method which provides the end user with a visual, tactical representation of data. A feature of one embodiment of the invention is that the data defines topographical features on a three dimensional object. A benefit of the invention is that users have a visual and tactile representation of their data.

Yet another object of the invention is to provide users with visual reminders of their health status. A feature of the present invention is the mapping of physiological data or user quantified psychological data such as mood during the morning, daytime, and evening onto a three-dimensional object, such that the object defines distinct topographical features and color as representations of physiological data. An advantage of the present invention is that the topographical features and color of the three-dimensional object quickly convey the user's health status. A further advantage of the present invention is that the continuing presence of the three-dimensional object representing health-data gives the health-data staying power in the user's mind by associating certain topographical features with certain health-related feelings and emotions.

A further object of the invention is the versatile presentation of health-data. A feature of the present invention is the ability for a user to customize the presentation of their health-data. An advantage of the present invention is that through customization of their health-data, a user can gain a more intimate and personalized understanding of their health-data that can be recollected by physically touching the data.

Yet another object of the instant invention is the presentation of health-data involving multiple health-affecting variables to a user at once. An advantage of the invention is that the data is presented in three dimensional form so as to be simultaneously accessed visually through color and shape, and also accessed in a tactile manner.

Still yet another object of the instant invention is providing a health- and emotions-data presentation method that is easily accessible to the visually impaired and children. The method utilizes physical shapes, materials, and textures (i.e. rubbery v. hard, wavy v. smooth) embodying health-data, such that the visually impaired can gain a more intimate knowledge of their health data. Another feature is presenting data as colored and tactile features on a physical object, such that children can also gain a better understanding of their health-data. In an embodiment, a three-dimensional representation of health-data is assembled by a user.

The present invention provides a method for visualizing health and emotions related data, the method comprising collecting a plurality of measurements of at least one data variable over a period of time, calculating an average, or determining a significant pattern in the data set such as time in range or a severe incident such as low blood glucose, an/or value of the at least one data variable or incident variable per unit such as in a day over the period of time such as a month, building a three-dimensional object having visual and tactile features that convey the averaged value, time spent in a specified range, and incident of notable health data patterns such as rapidly rising or falling blood sugar, of the at least one health-affecting variable to an observer.

The present invention provides various methods for making health data visceral, using the sense of touch, sight, and other embodiments senses integrated into the object such as sound and smell for representing health and emotions-related data, the method comprising collecting a plurality of measurements of a least one data variable over a period of time, calculating an average value or denoting the incidence of the at least one data variable over the period of time, or periods of time within specified ranges, building a three-dimensional object, haptic surface, or augmented reality object having features that convey the averaged value, or periods of time within specified ranges, incidence of at least one health-affecting variable to an observer.

In one example, the health data and associated techniques that may be utilized to construct three dimensional objects or sculptures of health data include: (1) average blood glucose over a period of time, and (2) thresholds that determine which shape will result on a given day on the sculpture. For instance, the thresholds may indicate when different types of shapes or protrusions are utilized: for instance, one may utilize an indent when a value is >50; a slight bump when value is =80−120; a small spike when the value is =130−160+; or large spike when the value is =161 or greater.

In other examples, the systems and methods may use a range of percentages as the basis for shapes. For instance, the three dimensional object may include a slight bump if BG is in range (between 80-140) for 75% or more in a day. The three dimensional object may include a spike if BG is out of range for 36% of the day or more. If there was an instance of a BG with 250 or more, an indent will be if by was below 55 for 5% or more during the day and the overall BG was not in range for 75% of the day or more. For days were there was a 5% or more of the day under 55 and there was also a BG above 150, the three dimensional object could include a raised mound that has a indent in it.

### BRIEF DESCRIPTION OF DRAWINGS

The invention together with the above and other objects and advantages will be best understood from the following detailed description of the embodiment of the invention shown in the accompanying drawings, wherein:

FIG. 1 depicts a flow chart showing the steps of the instant method in accordance with the features of one embodiment of the invention;

FIG. 2 depicts a perspective view of a spherical health-data sculpture in accordance with one embodiment of the invention;

FIG. 3 depicts a perspective view of a prolate spheroidal health-data sculpture in accordance with the features of one embodiment of the present invention;

FIG. 4 depicts a perspective view of a health-data sculpture that may be user-assembled in accordance with features of the present invention;

FIG. 5 depicts a perspective view of another embodiment of a three dimensional object;

FIG. 6 depicts another view of the three dimensional object of FIG. 3;

FIGS. 7A-D depict a user-assembled embodiment. FIG. 7A is a perspective view of another embodiment of a three dimensional object. FIG. 7B illustrates a process for assumingly the three dimensional object; FIG. 7C illustrates two halves of a three dimensional object to be assembled; FIG. 7D illustrates two halves of a three dimensional object to be assembled and the assembled form in (2);

FIGS. 8A-C depicts a multi-time period visualization of one embodiment. FIG. 8A illustrates a perspective view of a three dimensional object comprised of many layers assembled. FIG. 8B illustrates a schematic view of the three dimensional object. FIG. 8C illustrates a perspective view of a three dimensional object comprised of many layers assembled.

FIGS. 9A-9C depict further embodiments of the invention. FIG. 9A illustrates a top view of an embodiment of a three dimensional object; FIGS. 9B and 9C illustrates a perspective view of an embodiment of a three dimensional object;

FIG. 10 depicts a perspective view of a repositionable embodiment of the three dimensional object; the protrusions could also be controlled by a motor or other controllable force mechanism, thus making the same object have the ability to take multiple tactile forms and patterns, which could be controlled via a computer program that connects to a person's health data.

FIG. 11 depicts a perspective view of a wearable embodiment of a three dimensional object;

FIG. 12 depicts a top view of mobile device illustrating a virtual representation of a three dimensional object;

FIG. 13 depicts a top view of a mobile device with a calendar including virtual representations of three dimensional objects;

FIG. 14 depicts a graph of the raw data used in one embodiment

FIG. 15 depicts a perspective view of an embodiment of a three dimensional object;

FIG. 16 depicts a schematic view of the various components of a three dimensional object;

FIG. 17 depicts a view of an embodiment of a three dimensional object with tags that may be displayed on a computing device;

FIG. 18 depicts a flow chart showing top views of mobile devices that include virtual representations of three dimensional objects; and

FIG. 19 a view of an embodiment of a three dimensional object with tags that may be displayed on a computing device.

### DETAILED DESCRIPTION OF THE INVENTION

The foregoing summary, as well as the following detailed description of certain embodiments of the present invention, will be better understood when read in conjunction with the appended drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

### Health Data Collection

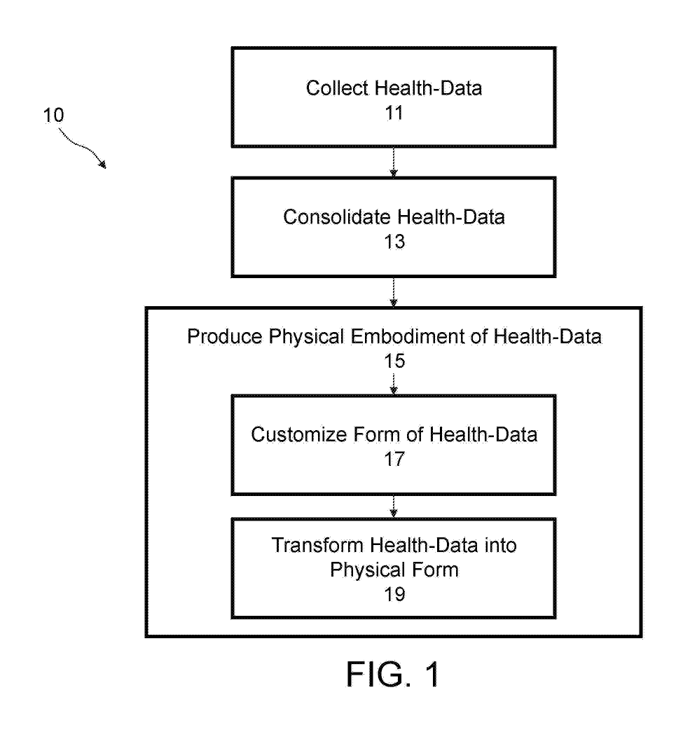

FIG. 1 illustrates an example method 10 for producing physical or three dimensional embodiments of health data. For instance, first, health data may be collected 11. Health data 11 may be any data that is collected relating to a patient's health. For instance, health data may include: blood glucose levels, hours slept, time spent being active, steps taken by a user, distance walked/run by a user, blood pressure, resting heart rate of a user, calorie intake, apnea-hypopnea index. Additionally, other types of data are also suitable, such as physiological changes triggered by emotions dealing with hunger, depression, elation, exposure to weather extremes, music, particular venues or experiences, and other variables that impact emotions. In one embodiment, health data is collected by a user of the method. In another method, the health data is collected by a third party service, such as a monitoring bracelet.

In another embodiment, the health data includes measurements of variables that affect the physical or emotional health of a user. Such variables may include financial data, time spent working, time spent participating in designated activities or hobbies, and time spent with children or other family.

A user or third party, such as medical or fitness personnel, can collect a user's health data using a number of different data collection tools. In one embodiment, these tools include blood glucose meters, continuous glucose monitors, insulin pumps, pedometers, sphygmomanometers, stethoscopes, wearable fitness trackers, nutritional information charts, scales that measure body mass, continuous positive airway pressure machines, heart rate monitors, pupil dilation monitors, breath-rate monitors, blood pressure monitors, kidney function, physiological fluids (e.g. gases such as carbon dioxide, methane, hydrogen sulfide, carbon monoxide, ketones, and liquids such as water, urine, tears, moisture in exhaled air, etc.) production, and variable or bi-level positive airway pressure machines. Additional tools used in other embodiments relate to software that allows users to record emotional feelings via an App on their smartphone/tablet or on the computer such as iMoodJournal, T2 Mood Tracker on smartphones and MoodPanda, Mood Tracker online. Several embodiments connect with third party data sources from one or more Apps. In one embodiment targeting Diabetics who self-log, the system uses the programming interface of or similar to MySugr, which allows buttons to be pressed when logging glucose for mood, general activity i.e. in transit, manual labor and others with an automatic location marker, which utilizes the phones geo-location.

As can be seen by the myriad tools that can be used with the instant method, the collecting health-metric data step 11 can be performed automatically or manually. For example, many blood glucose monitors require that a user manually input a blood sample to give a reading of the user's current blood glucose levels. These manual tools for collecting health-metric data normally give a reading, digital or analog, to be observed by the user and do not store data. For instance, digital data more readily facilitates 3D expression of the collected data. For these tools that do not store readings, the user of the instant method makes note of individual readings either manually or with the assistance of data entry software that can for example translate written numbers or logs into a digital form where a person photographs a list of numbers and they are made into a digital list.

Other tools utilized for the collecting health-metric data step 11 are automatic and store health-metric data without the user needing to manually request or take a reading. For example, many wearable fitness trackers actively keep track of several health-affecting variables at once and store data as it is generated without a user manually requesting data collection. These automatic tools for collecting health-metric data do not normally give a user a reading while health-metric data is collected. Instead, these tools normally store health-metric data as it is collected where the data can then be accessed at a later time. Still other data collection methods are sensor based, and automatically generate data based on concentrations of moieties in physiological fluids found in ambient air, commodes, clothing, etc. In one embodiment the TZOA environmental monitor relates to external factors such as allergens in the air rather than internal factors for health in case or self-determined ones such as exercise, insulin amounts used etc.

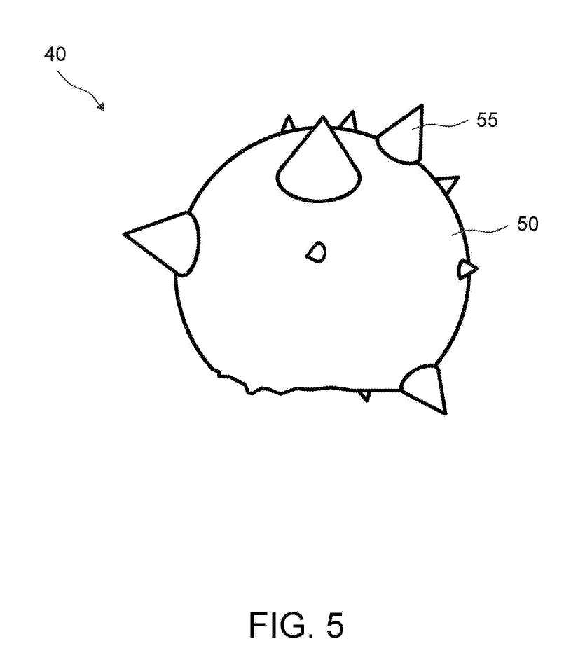

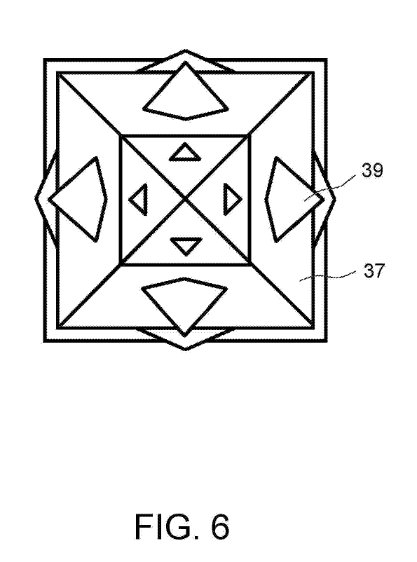

In one embodiment, for every data point within the health-affective variable data set, there is a second value representing time. In one embodiment, this time variable is an indication of the date and time the health-affective variable was collected. In another embodiment, this time variable is an indication of the amount of time that has lapsed since the previous variable was collected. A visualization of data pursuant to one embodiment is shown in FIG. 5, as shown in FIG. 5, the visualization includes surfaces with no topographical change as there was no data logged.

The duration of the collecting health-metric data step11 varies considerably depending on the particular health-affecting variable of interest and the interests of the user. For example, the collecting step can last as little as one day if the user is interested in the health-metric data associated with his or her blood glucose levels during a particular day, or within a few hours if the user is interested in the data associated with a physiological effect which is the result of an emotional experience Conversely, the data collection step can last for an entire year, or multiple years, such as occurs in an embodiment where a user is interested in their weight over a period of single or multiple years.

### Consolidating Health Data

After completion of the collecting health-metric data step 11, the next step of the instant method is consolidating the health-metric data 13. In an embodiment of the invention, the consolidation step 13 comprises averaging the health-metric data collected over at least two different time periods.

In an embodiment of the invented method, the raw health-metric data collected in the first step is averaged over at least two periods of time: a first period and a second period wherein the first period is shorter than the second and the second period is the total duration over which a user wants to visualize their health-metric data. For example, if a user uses the instant method to visualize their health-metric data in association with their weight over the period of a year, the first period would be a week or month depending on the preference of the user and the second period would be a year. Where a user utilizes the instant method to visualize their weight data over a year using a weekly average, an average weight value would first be calculated for every week over the year that user collected weight data. After weekly averages are calculated, the weekly averages are averaged over a year to obtain a user's average weight over the year. This could be used for other metrics such as BG measurements

In one embodiment, the method reviews the data and removes outlier values (values unlikely to represent a true physiological reading), as would happen if a single reading represents an incorrect value caused by measurement error (such as 0 or 500 for heart rate). In this embodiment, calibration errors do not result in the data set being compromised.

A salient feature of the instant invention is the customization of the method to the requirements of the user. In an embodiment of the instant invention, first and second periods of the data consolidation step 13 are chosen by the user of the instant method. For instance, a user interface of an application on a computing device may display to the user options for the time periods. In some examples, this may include sliders, pre-set time periods or allow the user to manually enter the time period numbers in the interface.

In another embodiment, the data consolidation step can be customized to include additional periods between the first and second periods that are always present. In the example where a user utilizes the instant method to visualize their weight over the period of a year, the first period would be a week and the second period would be the full year. If the user in this example wanted to customize the method to also visualize their weight data averaged over different time periods, such as each month of the year, then the health-metric data collected in the collection step would then be averaged over different periods. With this example, the consolidation step 13 would first calculate the weekly average of the user's weight, then calculate the monthly average of the user's weight and, finally, calculate the user's average weight for any other periods.

In an embodiment, a user can customize the granularity or margin of error of the method. A user can decide with what degree of granularity their health-data is visualized based on their needs. The needs of a user with respect to granularity can vary based on the health-affecting variable being measured and the reason for the measurement. With the instant method, the consolidation step can use any period of time as the first period, so long as there is sufficient data that can be averaged over the first period or data points that can be used to define a specific range that a user wants to know the percentage of time they were in such as BG between 80-120. Where a user of the instant method has a chronic condition that requires the constant monitoring of a health-affecting variable, the instant health-metric visualization method can be quite accurate. For example, a diabetic will or should take several readings of blood glucose values per day. An average value of blood glucose level on a particular day is then calculated using the several readings taken on that day. Average daily values are more accurate the more readings on which they are based. Showing increased granularity of average daily values allows for more specific weekly data values to be visualized which in turn makes the potential insights one may have relating to time periods of certain health greater. Nevertheless, a user who wants only a basic visualization of a health metric can decrease the number of data points in the used in the present method. A basic visualization of a health metric will have fewer topological features and will provide a less nuanced depiction of the health metric. This, however, is still helpful where general patterns such as migraines which may only happen a few times a month or even once a month are visualized over a full year in terms of when a person experienced the most headaches as well as someone with diabetes who is trying to keep track of the number of times they test or instance of testing each day as a metric not an average blood glucose number.

### Producing a Three Dimensional Object

After data consolidation, the next step 15 in the method is producing a three dimensional object embodying the data modified in the consolidation step 13. The production step 15 has two sub-steps, customization 17 and the transformation along with physical embodiment production 19. In some examples, this includes producing a physical object, and in others this may include producing a virtual three dimensional object that may be displayed on a computer, mobile, or other device display or in a virtual reality environment.

The three dimensional object may be any solid object that includes physical three dimensions or is displayed virtually to include three dimensions. In some examples, the object will have no openings and will be entirely smooth on its outer surface. In other examples, the three dimensional object may include different physical pieces, openings, or other physical features that are three dimensionally represented.

In an embodiment of the customization sub-step 17, the user chooses the tactile expression of data via the transformation step 19. During the customization step 17, a user of the instant method makes a number of choices that dictate the form of the physical object produced in the transformation step 19.

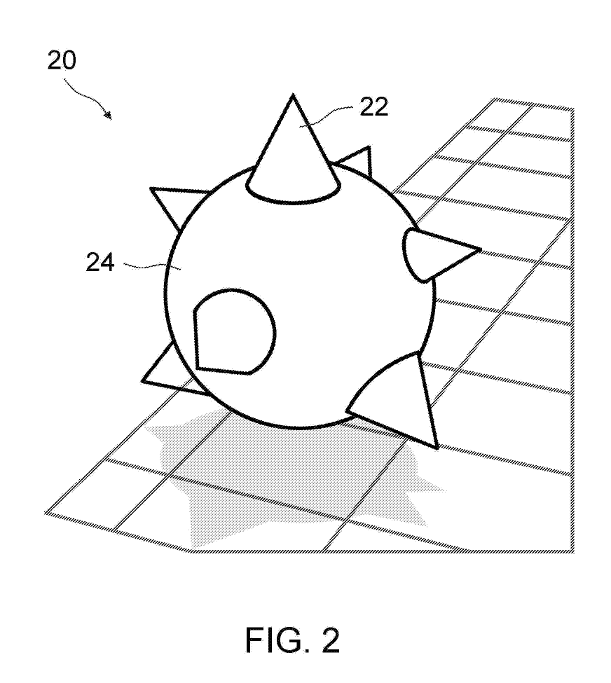

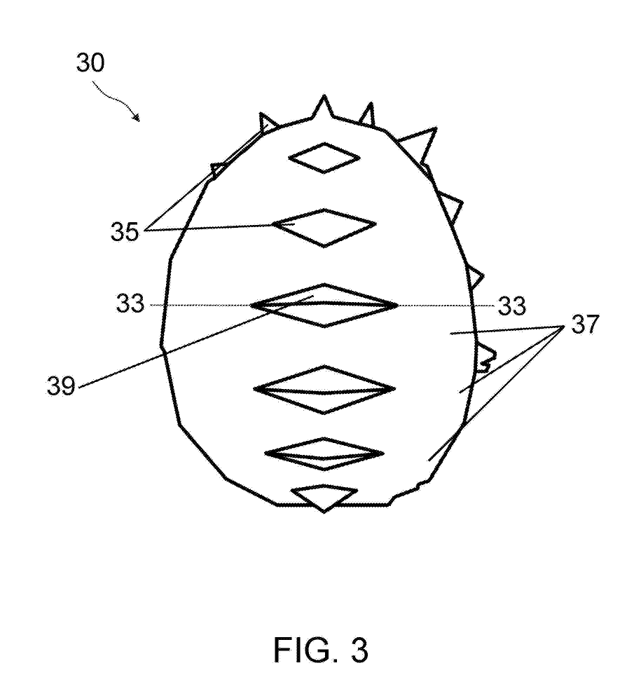

The first choice that may be made by a user or automatically chosen or predetermined during the customization sub-step is the shape taken by the physical object produced in the transformation step 19. The physical form produced by the instant method can be any three-dimensional shape, regular or irregular. An exemplary shape of the physical form produced by the transformation step 19 is discussed further in the description of FIGS. 2 and 3, below, with a focus on FIG. 3 which represents months, days, and weeks in a logical sequence of days in various planes.

In some examples, after a user or an automated system selects the physical form to be taken by their health-metric data, the user or automated control system may then choose a color scheme, and size for the physical form produced by the transformation step 19. Generally, the physical form produced in the transformation step can be any color. Alternatively, the method embodies an internal color standard adopted by, or developed by the user, to further designate the type of data represented. For instance, various colors may indicate various deviations or normal ranges (e.g. red indicates a high deviation, green indicates a normal range, etc.).

The user or control system may customize the three dimensional object in several embodiments. In one embodiment, a user can choose the scale of the object to be printed or visualized on a display (for example 2×2×2 in or 6×6×6 in) where all other things are identical including color and topographical feature. This embodiment is relevant for applications where the visualization is, for example, smaller physical or virtual sculptures that are made to be wearable as jewelry etc. or scaled to larger trophy like objects or more humble palm sized health mementos, or scaled to different sized screens or for different sized displays.

In some embodiments, a user can, with certain limitations, select the desired production methods (in this case 3D printers) and choose various textures an object could be printed in. This embodiment in particular is advantageous for someone who has visual impairment. For instance, if the user is blind, the texture could be the marker for health changes i.e. hard or soft and stretchy—this embodiment is a way to show overall averages as well for those who are blind and where color would not able to be seen. Although features could still be printed for the benefit of their caretakers or family. In one embodiment, the scale is used primarily to depict the time frame being represented and not primarily about showing good, moderate, or poor health.

In one embodiment, a user can choose to make the actual data available via a QR code that links to a secure cloud or local based website with their information, which is placed into the website or integrated into the production of the sculpture. This would allow them to also choose if they want to share metrics which the sculpture represents or to have it remain private and only known to them. In one embodiment, a user can also choose certain design features such as a sculpture that is magnetized for additional configurations i.e. on a calendar that utilizes them. In one embodiment, the visualization employs a large magnetic ring with 12 places to attach a sculpture representing most likely months, but where the placement need not be only confined to time—sculptures are be clustered by location a person spent time in—degree of health i.e. good, moderate, poor etc.

In one embodiment, more than one user can potentially choose to combine their health data with other users to create one sculpture representing joint health status. In one embodiment, a couple who wants to see how they spend their time or instances of walking together effects their individual health could be mapped so that on the same sculpture there could be a shared and individual data points. In such an embodiment, also month to month or week to week comparisons are produced on the same sculpture rather than a comparison of two different sculptures and if a user invokes the appropriate option.

### Transforming Health Data Consolidated to a Physical Object

During the transformation step 19, the data collected in the data collection step 11 and consolidated in the consolidation step 13 is translated to a physical or virtual, three-dimensional object whose shape, appearance, and topography were pre-customized during the customization step 17.

FIG. 2 depicts a health-data sculpture 20 or virtual three dimensional object 20 created using the instant method. In an embodiment, the health data sculpture 20 generally comprises a sphere 24 wherein the color, size, and topological features of the sphere represent the health-data collected, consolidated, and produced using the instant method. All aspects of the appearance of the health-data sculpture can be customized during the customization step of 17 of the instant method.

In an embodiment, the health-data sculpture 20 represents data collected with regard to a single health-affecting variable of a user or users, that data having been processed using the instant method. In this example, the radius of the spherical health-data sculpture 20 could represent a relative average of the user's health-data over the entire period of time that data was collected. Thus, if the user's average is over a normal range the radius of the three dimensional object 20 may be larger, when it is within a normal range the radius may be a medium length, and when the average is below a normal range it may be a small length. Additionally, some measurements could have a multitude of ranges or only two ranges (e.g., a normal measurement is above or below a certain level) such that more or less sizes could be used. Moreover, the size of the radius can vary depending on how severely the normal range is exceeded. In one embodiment, a larger radial number for a point would display a spike in the blood glucose level.

An advantage of the instant invention is the ability for a user to customize the method and resulting health-data sculpture. For example, in some examples, the radius of the health-data sculpture is normally largest when a user's health-data for a particular health-affecting variable as averaged over the duration of data collection is abnormally high and smallest where a user's average data is abnormally low. However, a user can customize their three dimensional object 20 by specifying that the radius of their sculpture in the customization sub-step. In another embodiment, the relationship between the radii of the spherical three dimensional object 20 may be the reverse of the above mentioned embodiment. In this embodiment, the radius of the three dimensional object 20 is smallest when a user's health-data for a particular health-affecting variable as averaged over the duration of data collection is abnormally high and largest where a user's average data is abnormally low.

Returning to FIG. 2, the color of the health-data sculpture 20 gives a visual indication to the user of the results of the health-data embodied by their three dimensional object 20. Color choice can be determined by the user. For illustrative purposes only here, when the results of data collection show that a particular health-affecting variable for a user averaged over the duration of data collection are poor, e.g., abnormally high or low depending on the particular variable being measured, the resulting health-data sculpture could be red. If the results are within the normal range for the variable being measured, the resulting three dimensional object 20 could be yellow. If the results are good, above or below average depending on the particular variable being measured, then the three dimensional object 20 would be green.

### Color of Three Dimensional Object

In another embodiment, the color of the three dimensional object 20 is pre-determined by the user in the customization sub-step 17 according to the user's aesthetic preferences. Or, in another embodiment, the color of the three dimensional object 20 is based on the relationship between the averaged data represented by a first three dimensional object 20 and the averaged data to be used to produce a second three dimensional object 20. For example, if the averaged data to be used to produce the second three dimensional object 20 shows healthy change, higher or lower average depending on the particular variable being measured, the second three dimensional object 20 would be green. If the change between the averaged data for the first three dimensional object 20 and the averaged data to be used in producing a second three dimensional object 20 is unhealthy change, higher or lower average depending on the particular variable being measured, the three dimensional object 20 would be red. If there is no change between the averaged data used to produce a first three dimensional object 20 and the averaged data to be used in a second three dimensional object 20, the color of the second three dimensional object 20 would be yellow.

In another embodiment, a second or subsequent three dimensional object 20 may be the same color as previous three dimensional object 20, just different shades. For example, if a user's first three dimensional object 20 represents abnormally high blood glucose readings, the three dimensional object 20 would be red. If the averaged blood glucose data to be used in producing a second three dimensional object 20 is still abnormally high, but not as high as the data for the first sculpture, the second three dimensional object 20 would be a lighter shade of red.

### Three Dimensional Object Protrusions

Returning to FIG. 2, the spherical three dimensional object 20 has conical protrusions 22 extending from the surface 24 of the three dimensional object 20. Such protrusions are depicted as extending in a direction that is normal from the surface of the sculpture. Protrusions 22 may be any three dimensional features of a three dimensional object 20 that extend out or are different shapes from a base three dimensional object. For instance, in this case the base of the three dimensional object or surface 24 is a sphere, and the protrusions 22 are cones. In other examples, the surface 24 or base 24 of the three dimensional object could be a square, pyramid, or other variety of shapes that may have relatively smooth or continuous surface. Other data expressions are envisioned, such that the protrusions extend at acute or obtuse angles relative to the surface and or each other.

Still other data expressions may define concave or concave surfaces on the surface. In the illustrated embodiment, the conical protrusions 22 embody the health-data averages of the first periods of the consolidation step 13 used to calculate the average health-data over the second period of the consolidation step 13. For example, if a user is diabetic and uses the instant method to visualize their average blood glucose level over a month, the second period, using individual days as the first periods, then the conical protrusions 22 represent the user's average blood glucose level on individual days or first periods. In an embodiment, there is a conical protrusion 22 for every first period used to calculate the averaged data over the second period. The height of each conical protrusion 22 represents the value of data averaged over a particular first period, where height increases as the averaged value for the particular first period increases. The conical protrusions 22 can be equally spaced over the surface of the spherical health data sculpture. As shown in FIGS. 3 and 6, a three dimensional object 20 may include four sections or faces that can be distinguished rather than a round edge—the sections being clearly visible in the top view of FIG. 6. On each of these large planes there are seven smaller long rectangular planes that have a data point with a transformation relative to the metric average. The form thus has a month that is represented sequentially from Day 1 to Day 7 by the points going form the top down to the bottom of the sculpture. Then, moving clockwise to the next “column”, one goes from Day 8 down to Day 14 from top to bottom, and then so on to move from Day 1 to Day 28 in this case as it is not a calendar month, however other embodiments could include each day of a given month in full. The specific transformation is consistent in the protrusion/indentation for each point—however near the top and bottom the protrusions/indentations are more narrow as they are put at the diagonal cross section of each geometric plane for a day—these geometric planes are not the same size and therefor the overall shape of the protrusions/indentations vary, although the values themselves which the protrude or are indentations is consistent.

One could divide a spherical form into portions like a geodesic structure so that there is no arbitrary form differentiation such as that in FIG. 3 near the top and bottom of the sculpture. It is possible to keep the data transformations consistent which protrude from the base form such as the sphere.

In an embodiment, the consolidated health data 13 method is averaged for health data collected 11 for more than one health affecting variable. For instance, a three dimensional object 20 can be divided into either two or more wedges, slices, ungulae, or quadrasphere, collectively referred to as segments. Just as averaged data for a single health-affecting variable can be embodied, through the instant method, into a spherical health-data sculpture that uses color and topography to give a visual, tactile representation of health data, the same spherical health-data sculpture or three dimensional object 20 can be divided into two or more equal or unequal parts that embodies averaged data of two or more different health-affecting variables, respectively, at the same time. In this embodiment, each segment contains averaged data of one health-affecting variable. The radius of each segment could be the same in a particular three dimensional object 20, or the radius could be different so as to produce, for instance, an ovoid shape. The user could then select a color scheme for each segment as to differentiate the particular health-affecting variable represented in each hemisphere. The color scheme of each segment is selected in the customization step 7.

FIG. 3 depicts an embodiment of the instant invention that shows averaged data of a health-affecting variable with added topography that allows a user to easily see and feel the trends in their averaged health-data over time. The embodiment comprises a health-data sculpture 30 that comprises a prolate spheroid having a semi-major axis along line 31 and a semi-minor axis along line 33. As with the spherical health-data sculpture 20 of FIG. 2, the prolate spheroidal health-data sculpture embodies averaged health-affecting variable data collected 11, consolidated 13, customized 17, and transformed 19 through the instant method. The prolate spheroidal health-data sculpture 30 uses size, color, and topography to give a physical, tactile representation of health-data. Where the prolate spheroidal health-data sculpture embodiment differs from the spherical embodiment comprises additional topographical features which provide a means for a user to follow the trend of her health-data sequentially.

In the prolate spheroidal embodiment, the surface of the spheroid over the semi-major axis is flattened into planes 35 that approximate the curvature of the prolate spheroid. Again, the general size and color of the prolate spheroid three dimensional object 20 the same meaning and possibility of customization that the size and color do for the spherical three dimensional object 20 embodiment. With the prolate spheroidal embodiment, the conical protrusions 22 of FIG. 2 are replaced with square pyramidal protrusions 37 that extend radially from the surface of the prolate spheroidal three dimensional object 20. The square pyramidal protrusions 37 embody the health-data averages of the first periods of the consolidation step 13 used to calculate the average health-data over the second period of the consolidation step 3. The height of each square pyramidal protrusion 37 represents the value of data averaged over a particular first period, where height increases as the averaged value for the particular first period increases.

In an embodiment, data averaged over a first period is represented on the spheroidal three dimensional object 20 by a square pyramidal recess 39. A square pyramidal recess 39 represents data averaged over a first period where the average value is below an expected range. For example, normal blood glucose levels for a person are 80-120 mg/dL. If a user of the instant method had an averaged blood glucose level over a first period of 65 mg/dL, this would result in a square pyramidal recess 39. The depth of the square pyramidal recess represents the value of data averaged over a particular first period, where depth increases as the averaged value of the particular first period decreases. The depression in the surface of the spheroid provides a means for physically and visually indicating a depression, drop or decrease in average data value simultaneously. As such, this data expression also relies on the mental association of a physical depression, with a depression in chemical concentration of a particular moiety.

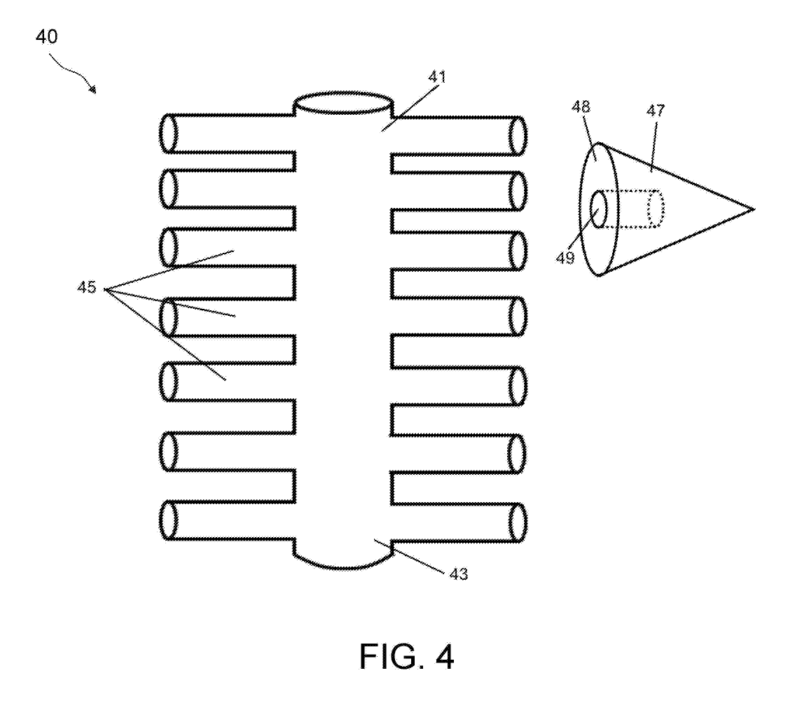

FIG. 4 depicts a user-assembled health-data sculpture 40. In an embodiment, the health-data sculpture includes a scaffolding 41 comprising a central cylindrical member 43 and a plurality of laterally extending cylindrical members 45. In the embodiment shown, the cylindrical members 45 extend perpendicularly from the longitudinal axis of the central cylindrical member 43, but other angles are envisioned. Each tangential cylindrical member 45 represents a particular first period over which health-data was averaged. In this embodiment, the color of the scaffolding represents particular health-data averaged over a second period. The values for data averaged over a particular first period are represented by solid conical segments 47, the conical segments 47 having a circular base 48 and a center defining a cylindrical void 49 extending along the longitudinal axis of the conical segment from the circular base toward the apex of the conical segments 47. Cross sections of the cylindrical voids 49 are slightly larger in radius than the radius of the tangential cylindrical methods so that the conical segments can be reversibly, slidably received by the tangential cylindrical members 45. The conical segments 47 embody the health-data averages of the first periods of the consolidation step 13 used to calculate the average health-data over the second period of the consolidation step 13. The height of each conical segment 47 represents the value of data averaged over a particular first period, where height increases as the averaged value for the particular first period increases.

Regarding FIG. 5, in one embodiment, the three dimensional object 20 or sculpture 40 is made using a geodesic sphere 50 with prongs on it so that the conical forms 55 are placed on the sphere 50. The sphere 50 may be relabeled with numbers representing a desired time frame for data points and the cones are left without color. In another embodiment, a number for the metric correlating to a color that is mixed and then painted on them—like a personal health based sculptural paint by numbers thus encouraging health awareness and artistic development at the same time.

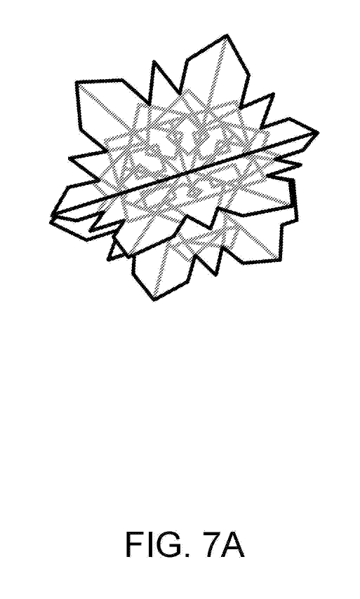

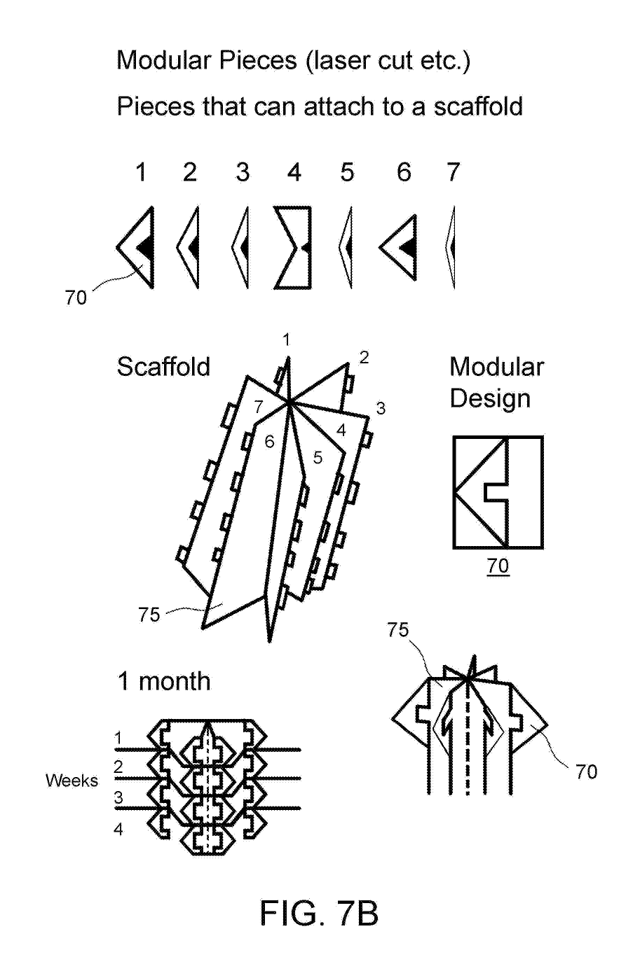

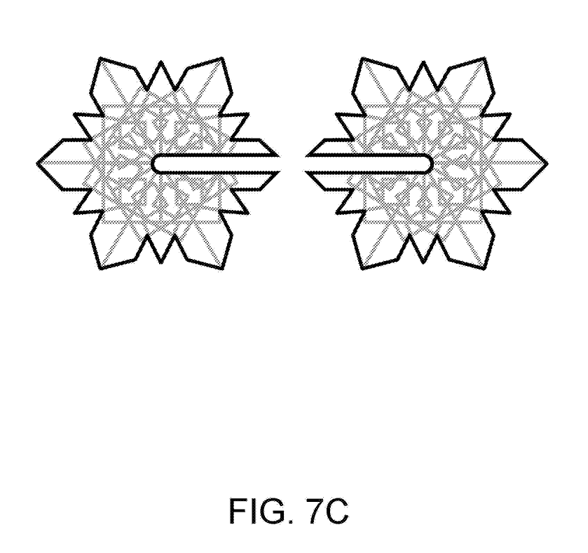

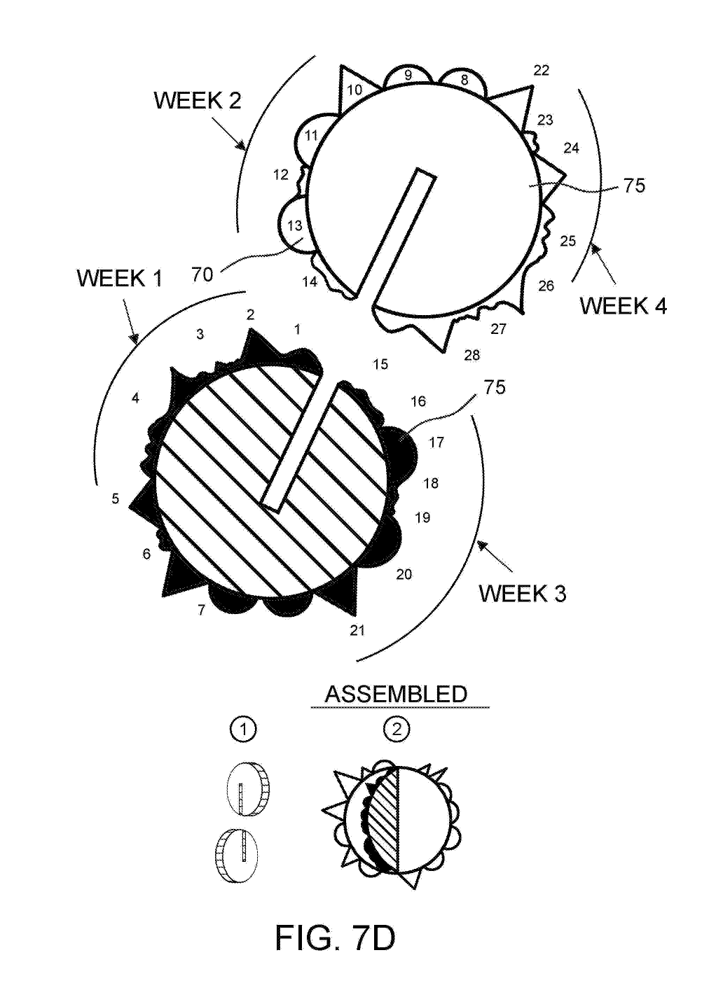

Another embodiment of a user-assembled embodiment is depicted in FIGS. 7A-C. As shown there, each visualization piece is defined by pieces that can attach to a central scaffold to represent one or more months of data. FIG. 7B depictures a scaffold 75 with tabs or other physical connection pieces that can connect to the pieces 70. As illustrated, each flap of the scaffold 75 may illustrate 1 of 7 days of a week, and the each tab on one of the flaps represents a different week. Accordingly, the entire three dimensional object 20 or sculpture 40 represents an entire week. FIG. 7C illustrates an embodiment of how to time periods may be assembled together. FIG. 7D depicts the details of the laser-cut user assembled embodiment of 7C, and the division of time periods within this embodiment. Here the scaffolding 75 flaps are shown separated and how they can be connected, and what the pieces 70 represent which attached to the scaffold 75.

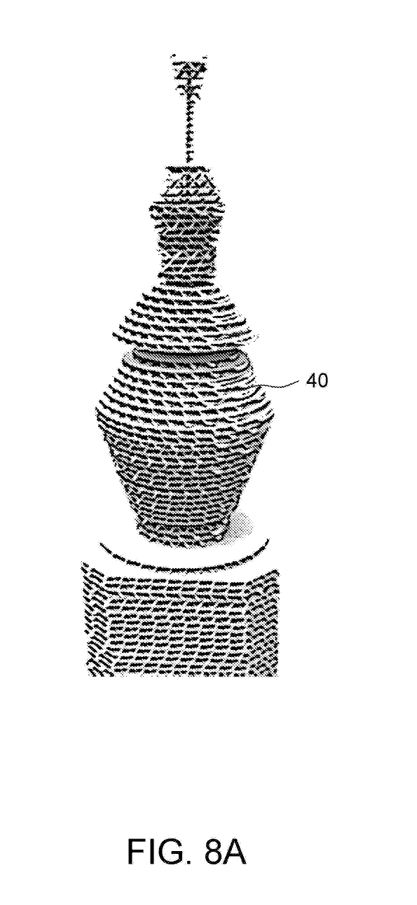

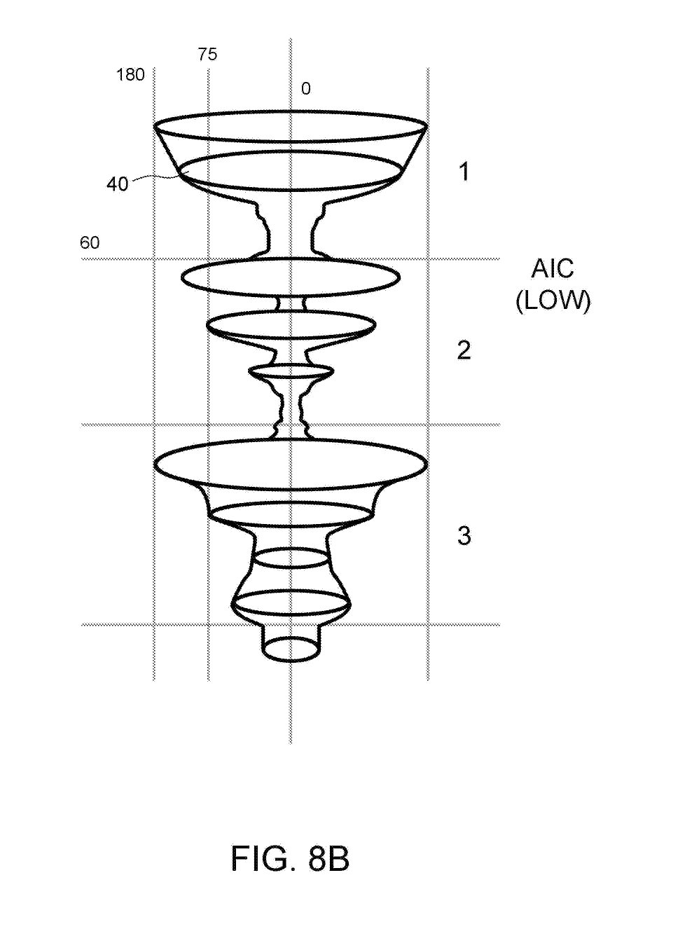

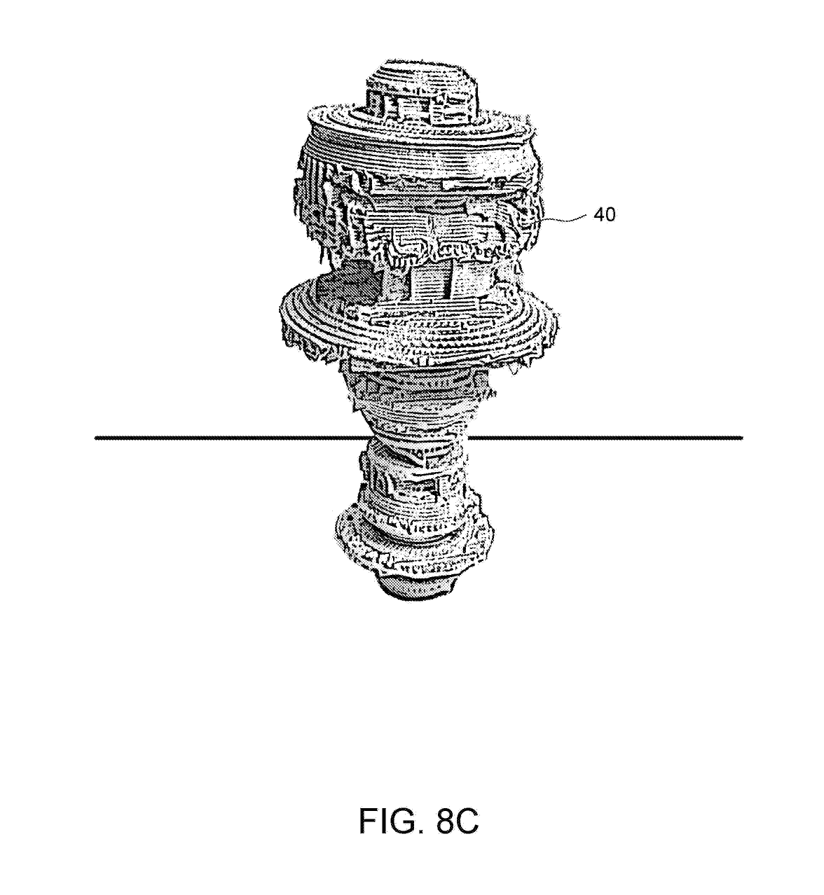

FIGS. 8A-C illustrate other embodiments of a health sculpture 40 which create disks which are stacked on each other to form a tower. FIG. 8A is also another example of interlocking laser cut forms. This embodiment facilitates the creation of a sculpture 40 or three dimensional object 20 using continuous glucose data to form a more nuanced view of large sets of data, with one visualization featuring three months of data usually looks like in the form of an Hba1c test.

As shown in FIG. 8B, the form is still segmented and in this embodiment each third represents one month. Various embodiments exist to depict this data set in many different forms and also possibly self-assembled. In this embodiment, the pieces were machine cut using a laser cutter and divided into labeled disks that could be assembled—see FIG. 8A.

In an embodiment of the invention, the data collected and averaged to create a three dimensional object 20 is stored on a secure website that will be connected to an app or software to which the users have access. Each user is given a username and password to retrieve their health-data. Additionally, a Quick Response (QR) code can be affixed to a health-data sculpture that, when read, brings a user to the raw data used in creating that particular health-data sculpture.

The three dimensional objects 20 of FIGS. 2-4 can be made of any substance capable of being shaped through molding, printing, carving, laser cutting, or sewing, or can be virtual representations as disclosed herein. For example, the health-data sculptures can be made from polymer, wood, metal, ceramic, glass, fabric, and combinations thereof. In some embodiments, the health-data sculptures are made from Polyactide Polymer (PLA biodegradable plastic). The health-data sculptures of the instant invention can be solid, hollow, or a combination thereof. For example, in an embodiment, the spherical portion of the spherical health-data sculpture 20 of FIG. 2 is hollow while the conical protrusions 22 are solid. As a further tactile and mental cue, the weight of the sculpture can be varied, depending on the gravity of the ailment or emotional event which the data represent. As such, substrate may be chosen based on this particular cue.

### Manufacturing of Physical Objects

Returning to FIG. 1, health-data can be translated into the physical, three-dimensional health-data sculptures and their parts during the transformation step 19 in myriad ways which the user can preview on an app after uploading their data or as templates before uploading their data, which refer to a 3-D form with implicit tactility before printing. For example, the health-data sculptures can be produced using 3-D printing, conventional metal or plastic molding or cutting methods, carving, sewing and combinations thereof. In an embodiment, an entire health-data sculpture is produced as a finished product in one step. Entire whole health-data sculptures can be produced using 3-D printing. Alternatively, parts of a health-data sculpture can be made or molded separately and then assembled after initial production. The spherical portion of the spherical health-data sculpture 20 and its conical protrusions 22 can be constructed separately and then assembled using gluing, melting, or sewing.

### Advantages of Disclosure

An advantage of the instant method is representing health- or emotional-related data in a physical, tactile form that can be more meaningful to a user than simply viewing raw or averaged health-data on a graph or spreadsheet. The instant method, however begins as a 3D model, which represents the tactile information such as the indents and protrusions, which a user can explore prior to production. Conventional methods of representing health-data give a number, graph, or spreadsheet that can be inaccessible, difficult to understand, and easy to forget. The health-data sculptures of FIGS. 2-4 present health-data to a user in a way that is accessible through more than sight, or provide a more concrete visual representation in the case of a virtual three dimensional object displayed on a screen or in virtual reality.

With the health-data sculptures embodying health-data through shape, color, and topological features, a user can glean a more intimate, personal understanding of their medical data. Further, in the examples where the health-data sculptures 40 of the instant method are physical objects, (tactile blueprints via software or an app) the data embodied in the sculptures has more staying power in a user's mind as the sculpture is striking in appearance. As long as the health-data sculpture is kept or displayed, it is a reminder to the user of their health-data. Therefore, the instant health-data sculptures have more staying power than health-data viewed once on a blood work results printout that likely gets filed away.

The invented method may rely on a vocabulary of tactile expressions which the user acquaints herself, not unlike the vocabulary adopted by some social media users, which may be represented and indexed in an app with a key or even through the haptic features that are triggered by textures on for example a tablet screen i.e. a depiction of rough texture that has many quick and intense haptic vibrations when felt or touched via a touchscreen or other display method. This vocabulary further facilitates the mnemonic means for recollecting data once the device is hefted at a later date, such that the sculpture will harken back the emotions associated with a significant life experience or event, such as a happy or sad moment, an illness or a cure, a moving image or sound, or itself a memory.

A further advantage of the instant invention is the ability of the health-data sculptures and virtual representations to better inform users that are either visually impaired or children. As noted supra, graphs or printouts of health-data may do little to inform those that are visually impaired. The health-data sculptures of the instant invention provide a tactile representation of health-data where a visually impaired user can literally feel their health-data. The feeling of their health-data may grant visually impaired users more information regarding their health data than just hearing their results described. Or, the feeling of their health-data through the health-data sculptures of the instant invention can supplement a visually impaired user's understanding of an oral description of their data.

Via an app each day could be signaled as an audio track, such as “January 1st” the surface or a tablet for example would become rough or smooth via the haptic sense or via actual texture changes on future interfaces so that each day has a unique tactile sensation that can be felt either as an overall average for a period of time or for increments within the largest unit of time such as a day. Each smaller increment could be felt sequentially with an audio signal that changes a change from one segment of time to the next. Via an app in this form even for someone who may be visually impaired audio commands could be given that modulate the conditions for the haptic sensations corresponding to their health data and thus could be customized without seeing anything. For example one could say, “Show me all the highest blood sugar days first” and the app would exaggerate these strong haptic vibrations so that they could distinguish the number of highs and then they could say, “Show me the overall health for this month” and a more subtle varying texture could be felt.

As with visually impaired users, the instant health-data sculptures are particularly useful in giving children an understanding of the health-data. Where conventional health-data representations can be difficult to contextualize for children, the visual, tactile form of the instant health-data sculptures provide an alternative representation to aid in a child's understanding of their health data. The color and topological features of the health-data sculpture created for a child can convey the connotation of their health-data where graphs and data points may not. The health-data sculptures in FIGS. 2-3 provide a means for conveying the connotation of a child user's health-data. Additionally, the health-data sculpture of FIG. 4 can be used as a tool to teach a child user about their health-data by allowing the child to build their own health-data sculpture or by assembling the health-data sculpture in front of a child user while explaining the meaning of the pieces.

In one embodiment, self-assembly techniques are the educational aspect of the visualization and allow for modular and perhaps collaborative ways to look at the sculptures. In some embodiments, the end users can modify them based on what someone wants to avoid, e.g., putting red conical structures on various points to represent a pattern a patient is trying to avoid as another way to visualize their health objective.

In the self-assembling embodiment having a standard size two people or the same person could take apart two different sculptures dividing the data set in half and put them back together for a side by side comparison on the same object rather than two separate objects.

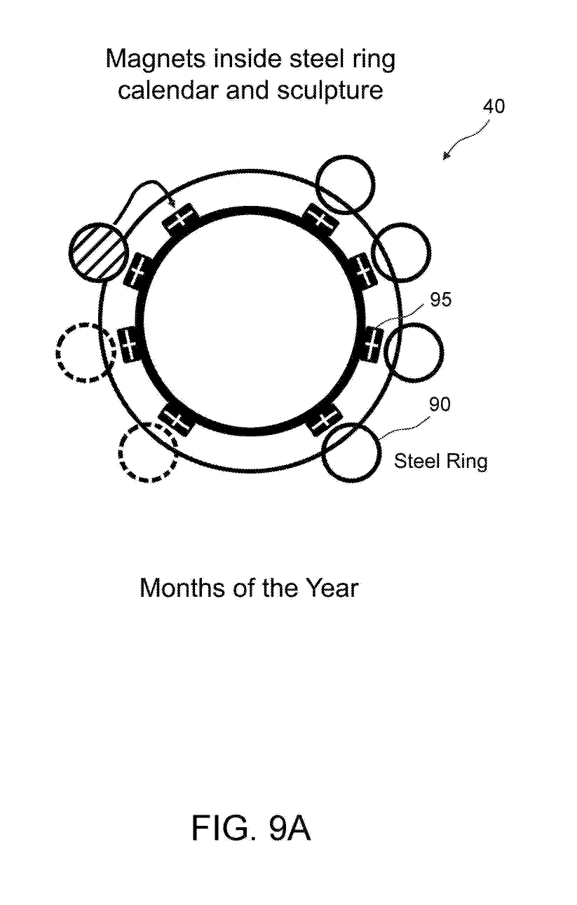

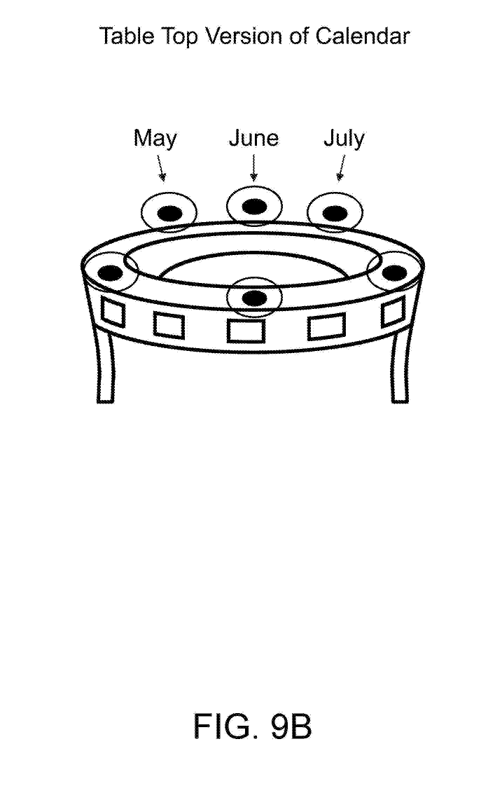

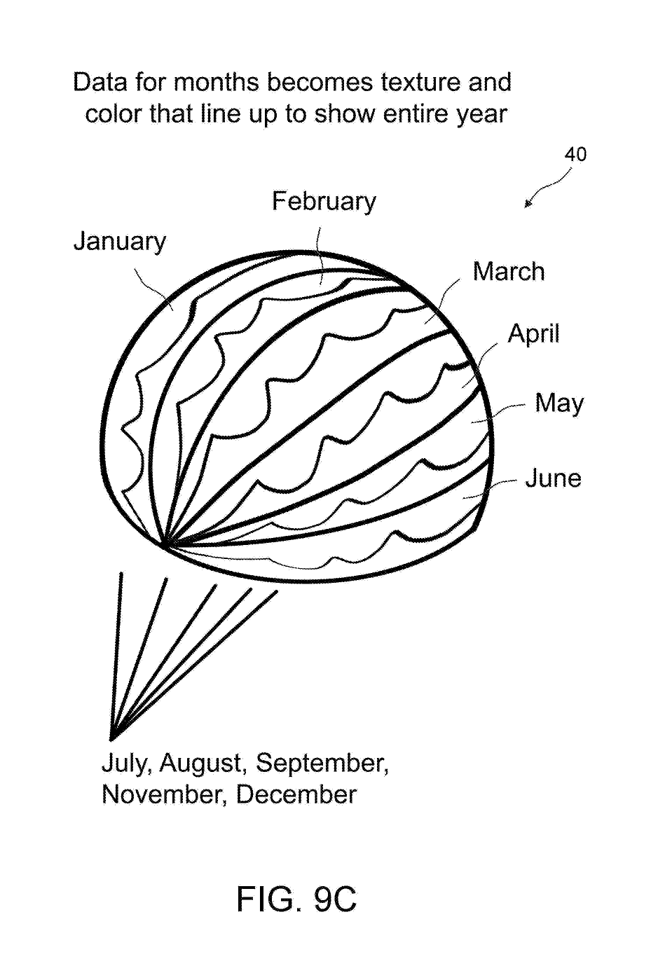

In one embodiment, each health data sculpture 40 is a piece of a larger sculpture 40, such as the embodiments shown in FIGS. 9A and 9B. FIG. 9A is a calendar accompanying multiple data sets and using magnets 95 and steel rings 90, while FIG. 9B is a table top version of a calendar. FIG. 9C depicts a sculpture 40 showing use of the same data used for a month or week sculpture after a year wherein the subpart sculptures for shorter time periods are turned into a larger sculpture albeit in a different form so that it would not be assembled but rather used differently to represent a larger amount of time. In this embodiment, the larger sculpture varies depending on progress or regress over a set period of time. In this embodiment, the user can see whether their metrics are improving.

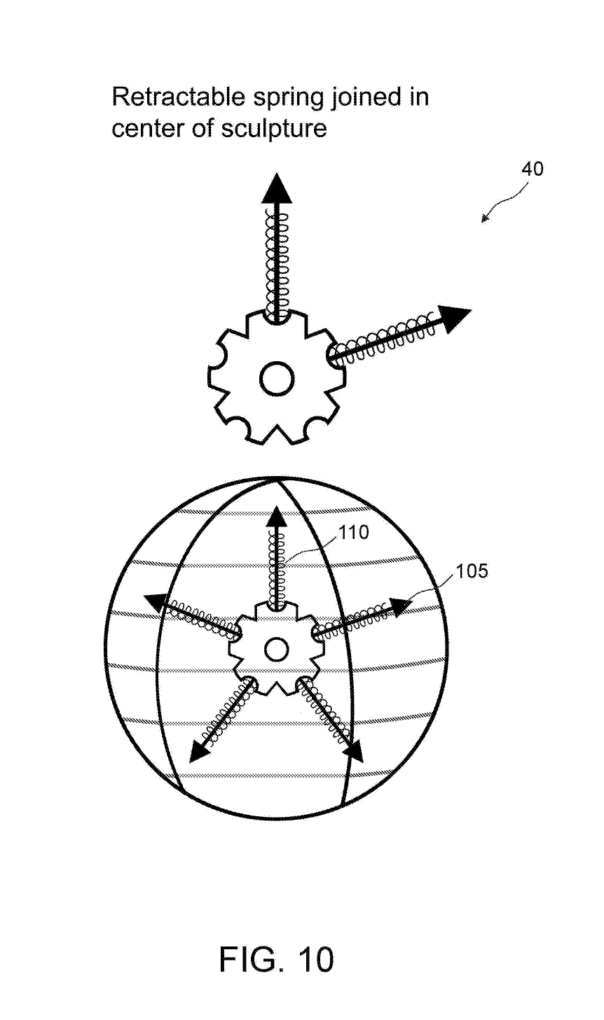

In another embodiment, shown in FIG. 10, the protrusions 105 are retractable (a button, in one embodiment). This embodiment employs either haptic touch sensation or augmented reality—wherein the values are programmed to respond in real time to changes in health without structural change to the sculpture and thus these technologies. As far as retractable parts—embodiments use spring loaded 110 or use other methods for retractable and adjustable surfaces so that they sink in or rest into the sculpture, as shown in FIG. 10.

The haptic technologies and augmented reality screens/surfaces, which bypass the production methods outlined above, are used in one embodiment, which in some instances could be a precursor to producing the health data sculpture as a standalone but which may also be used independent of the actual production process. These technologies make data visceral but do not actually create a physical object but rather a haptic sensation or in the case of augmented reality the illusion of an interactive tangible object with topographical features.

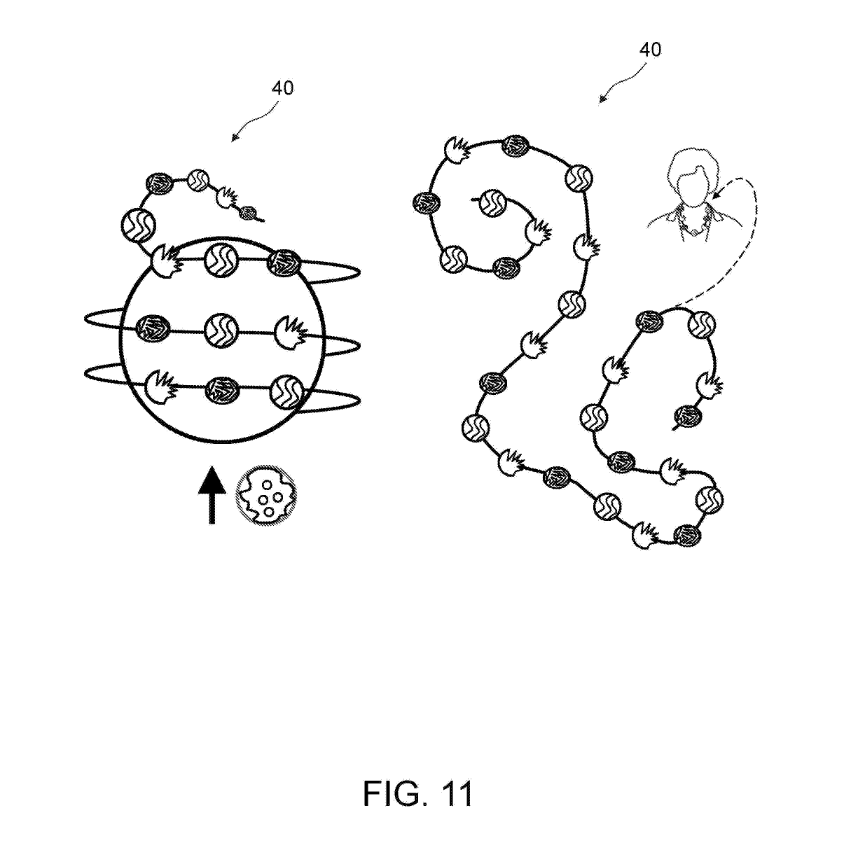

In one embodiment, shown in FIG. 11, the health data sculpture is worn like jewelry similar to a medical alert bracelet. In this embodiment, the visualization is akin to meditation beads or a rosary. In this embodiment, the sculptures 40 are scaled down to be more aesthetic to show something positive that can be worn or could actually take a different form. In this embodiment, each day is represented as a bead—like a rosary with a specific color or texture associated with the metric that day and thus it could be a necklace and a day by day tactile chart. (This embodiment could then be attached to a larger holder with indentations or magnets that would allow it to viewed as a whole in this case as a month.) In another embodiment, the visualizations take the form of sculptures as trophies or badges. Again the end user has the option to scale the sculpture up so that it is no longer just about being tactile but more as monument/trophy i.e. a 3×3 ft health data sculpture, which no longer can be felt easily all at once but which shows a time frame in an aesthetic way that can also be felt sequentially day by day.

### Virtual Representations of Three Dimensional Objects

In a different embodiment, the sculptures that are comprised of parts that allow them to transform into different sculptures over time rather than have a new print or production for new data. These would follow the same logical sequencing, use of color, and texture but employ technology that allows shape and color the changed via a data that may be updated daily.

This could be achieved if the sculptures were displayed on a smart device with a blue tooth that connects to a cloud which would then change the texture and with a LED/LCD screen to display the averaged color day to day. In one embodiment, this reversibly deformable version uses haptic screen technology. This embodiment is a departure from the 3-D printed process but could very well represent that way texture and color can be shaped on the same object. In another embodiment, the visualization also includes a screen that changes a tactile feel or texture. This embodiment is important in that it is not production but utilization of haptic sensation and textural manipulation with a visualization sculpture.

The embodiment do not show an instance of something like panic attacks as a diagnostic representation or singular data visualization but contextualizing health events with the variable of time among other things such as sleep patterns in one embodiment. In other words, the embodiments of the instant invention are not simply about averaging data and presenting same to end users. The physical embodiments of the data may be shared to create empathy.

Empathy is important in these embodiments as it covers all users regardless if they are a doctor, patient, mother, child, partner or person working to better understand themselves—the sculptures make something, which is not often able to be sensed or tangible like data visceral.

An important function of the sculptures in one embodiment is to be able to share information with healthcare providers such as a doctor. Further, the embodiments allow people to communicate information that is often locked in jargon and highly technical terms. Also as noted in FIG. 11—a doctor could have a receiving holder for someone data to fit into in the days of month as shown in the data rosary model.

In some embodiments, the data will be represented as virtual data displayed on a screen, when a 3D printed or other fabricated physical object is not available, practical or convenient. For instance, a three dimensional object 20 may be displayed on the screen of a smart phone, smart watch, wearable, computer, or other computing device with a display. In some embodiments, a hologram or virtual reality representation will be utilized to display the three dimensional object.

In embodiments that include the display of a three dimensional object 20, the computing device will add features to mimic the three dimensional look of the three dimensional object 20. For instance, the control system may utilize templates that can be modified proportionally based on the health data for a particular user. Accordingly, the health data may be turned into a certain number of data values that will then be transformed into a virtual representation. The data vales may then be processed to determine shape changes to make to the virtual representation of the three dimensional object for display on the device.

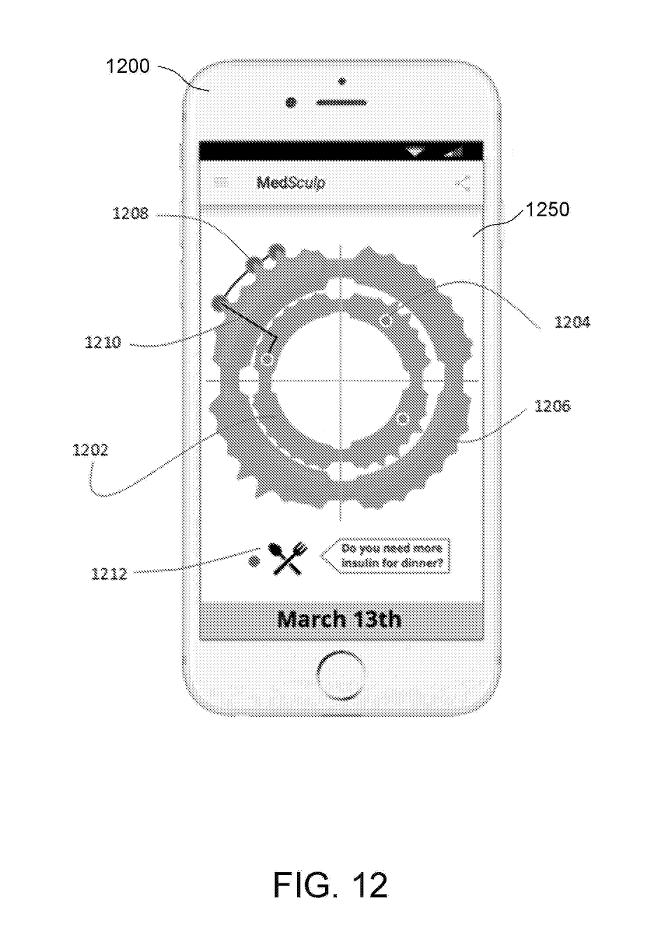

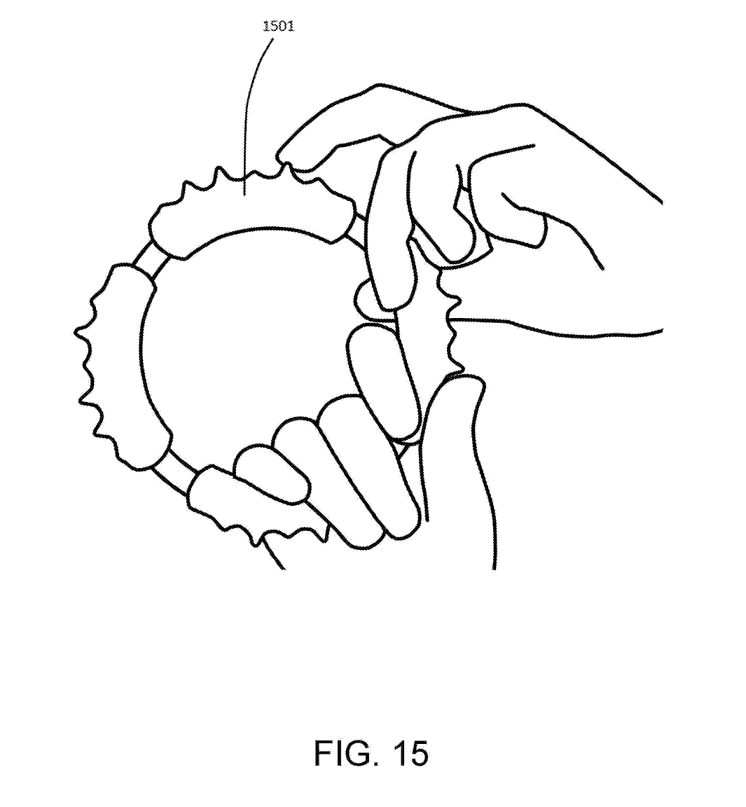

For instance, FIG. 12 depicts the display of a computing device 1200 that includes a display 1250 for displaying the three dimensional object 20, which may be ring 1501 from FIG. 15. Specifically, FIG. 12, depicts one iteration of diabetes data that may be displayed to a particular user. This view of a digital or virtual iteration of the diabetes data shows one day with in this case two data rings. The inner ring 1202 is for medication (in the depicted case insulin) and has times that a patient marked as (e.g. orange) dots 1204. The outer ring 1206 is the depiction of the patient's blood glucose over the same period of time. In some examples, the outer ring 1206 will be yellow to designate an overall value that is slightly above their target average. Thus, the color feedback provides a quick summary of the day in terms of blood glucose. In some examples, red dots 1208 behind the yellow spikes in the upper left hand corner are hours with high blood sugar that are connected to that days' last meal. The data shapes have a visual black line connector 1210 to make it easier for the end user to make the correlation between insulin dose, meal, and high blood sugar.

Based on the correlation between a meal/carb entry, on a pump (or manually entered) and elevated blood glucose meter/Continuous Glucose Monitor value, the app or other computing device can make a suggestion that more insulin was needed for a particular meal, as shown by the indicator 1212.

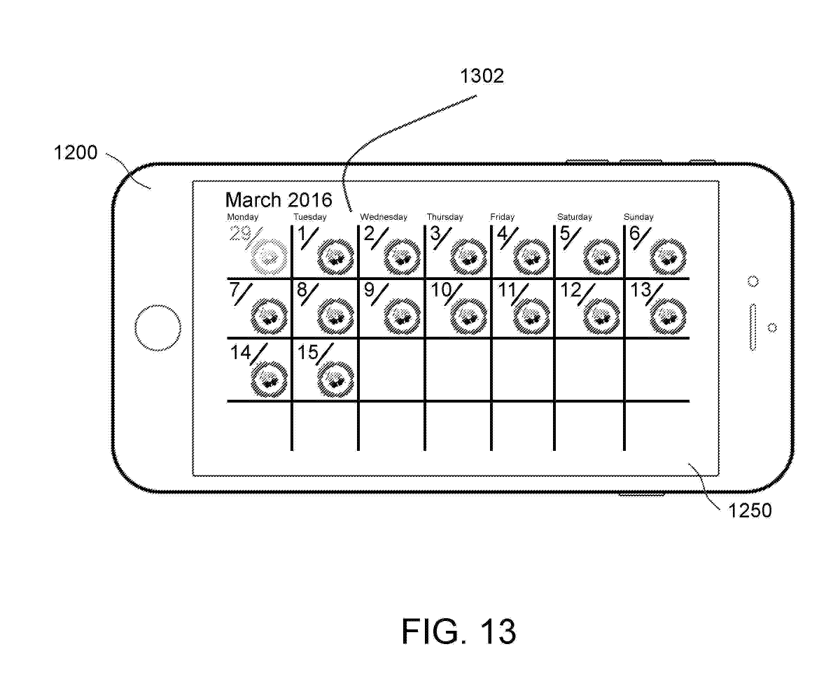

As shown in FIG. 13, there the same visual ring shapes as shown in FIG. 12 are depicted in a monthly matrix of individual days depicted on a calendar 1302. Each day has a form that summarizes that day and can be easily compared. For example, the end user can note that Tuesdays are consistently green, which means good blood sugar and the first week of the month had high blood sugar when a friend was visiting from out of town. In one embodiment, this data is synchronized with a calendar such as an online calendar or other time keeping application used by the end user so that events and behavior of the end user's life can be connected to their blood glucose.

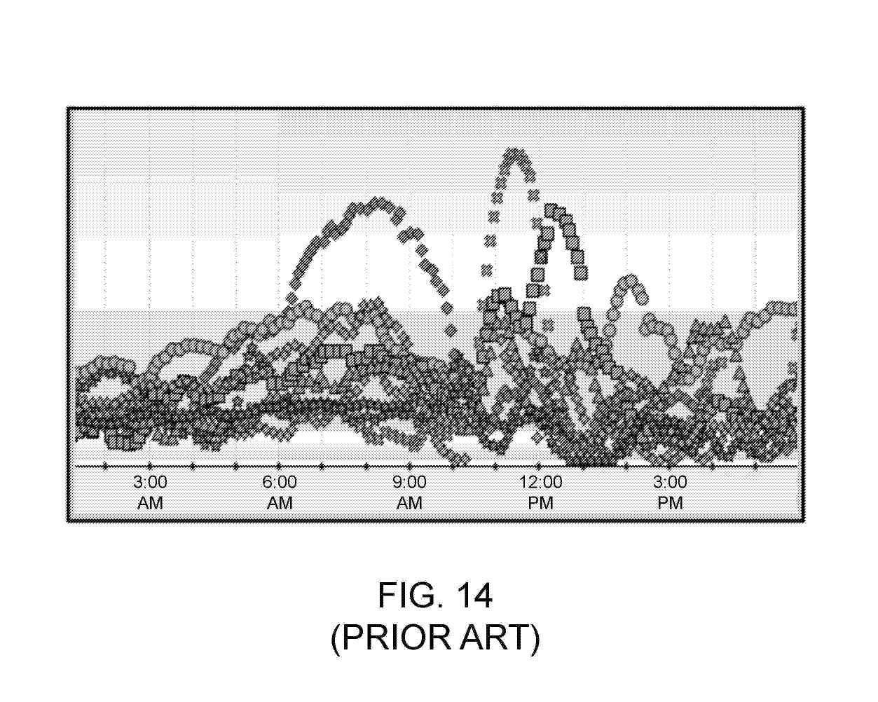

In one embodiment, the system is designed to simplify diabetes data into a compact visual language, as shown herein. For example, health data can often be collected and plotted conventionally, as shown in FIG. 14. Unfortunately, only 12% of the US population is categorized as having proficient health literacy that would likely allow end users to derive value from the current forms of visualized data as shown in FIG. 14. The end results are mistakes and health problems costing estimated at up to 238 billion per year in the US attributed to poor health literacy, where an estimated $15 billion is attributed to poor health literacy for the diabetes population alone, which requires intensive management by patients including daily health data collection. The US Center for Disease Control reports proficient numeracy, which is associated with health literacy, is even lower at 9% and diabetes researchers have cited data visualization as a way to improve comprehension.

A visualization embodiment is shown in FIG. 15. The depicted embodiment 1501 details the information in the shapes.

Currently type I diabetes sufferers using a CGM have the most data with over 8,000 blood glucose readings a month, however, increased CGM use in the type 2 diabetes populations is likely with increased reading accuracy, proposal for increased Medicare coverage, and initiatives by monitoring and technology companies to make CGM technology cheaper and more discreet. The system as designed can create actionable visualizations form this data while remaining easy to use and intuitive.

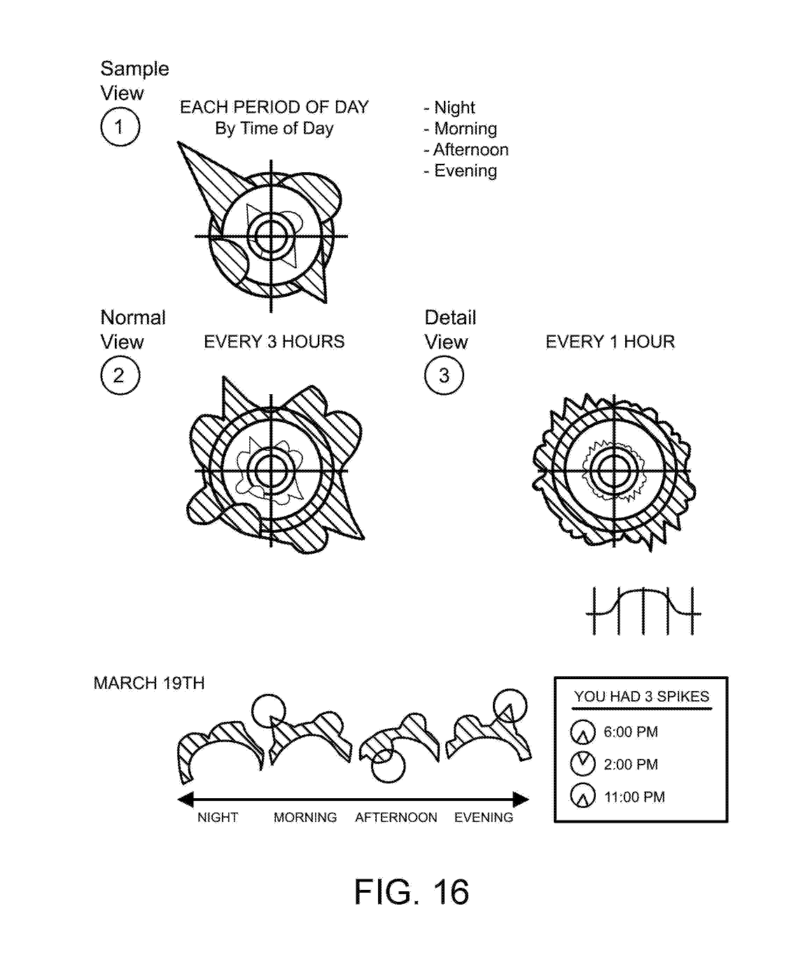

Additional embodiments for a three dimensional object 20 or sculpture 40 are shown in FIG. 16. FIG. 16 illustrates a sample view of how each time period of the day could be visualized. This representation may be virtual or physically printed or manufactured.

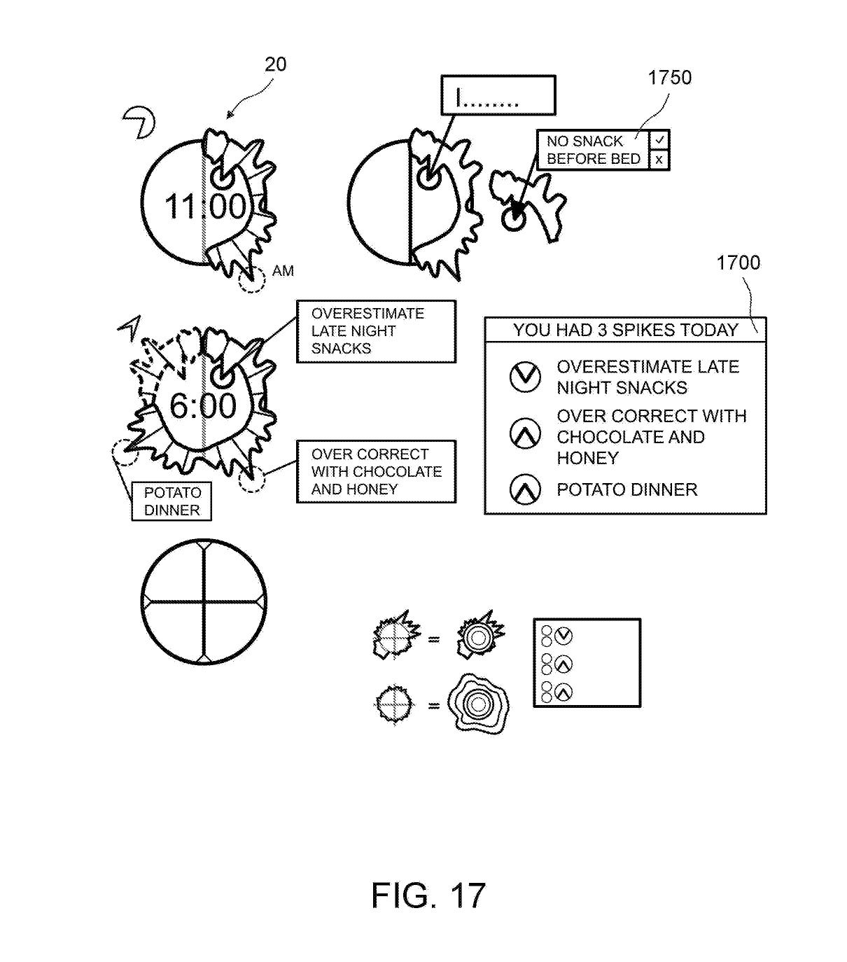

Another embodiment is shown in FIG. 17. FIG. 17 illustrates an example of a virtual or a physical embodiment of the present invention. For instance, a display 1250 may indicate a key 1700 that summarizes the spikes on the screen 1250, while tags 1750 may be included that highlight the events on the three dimensional object 20.

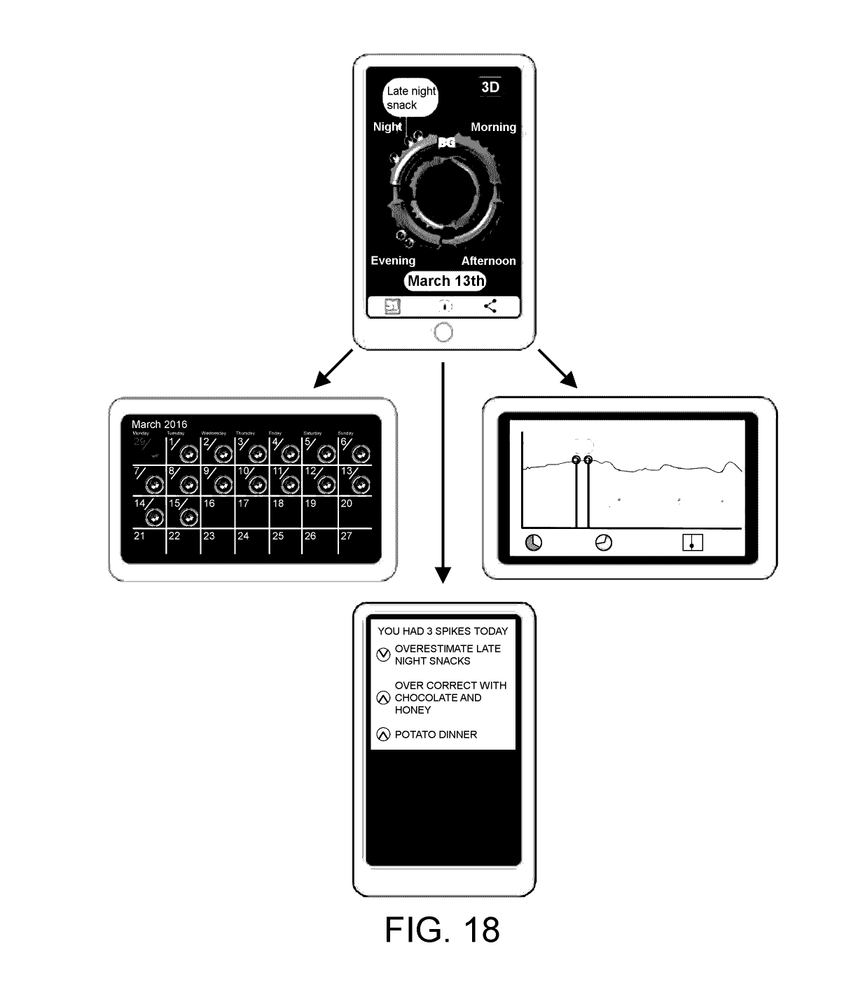

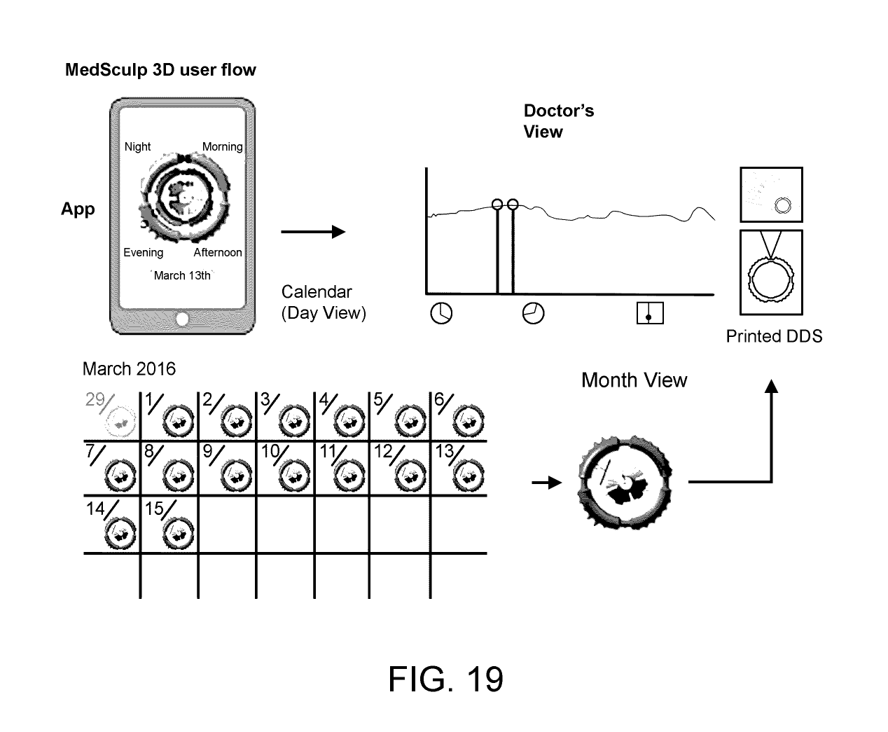

FIG. 18 shows views of several features of an application which implements the drawings of embodiments shown in prior Figures such as 16 and 17. FIG. 19 shows several views of an application that is used by both by an end user and a doctor, with different views available to each person.

It should be noted that shapes, before they are printed, could be used as personal icons or emojis for communication and thus are part of the invention as they are generated from the same parsing of the data, show shape and color, reference tactility, but are not printed as their medium would be as an icon, emoji, or summary of health to be shared and sent digitally and which may or may not be produced at a later time. Some users may want to selectively produce via the 3d digital file only certain health data sculptures such as a month that was particularly good or challenging or on an anniversary or for a special event. In other examples, the 3D digital file may be utilized for a virtual representation.

### Hardware Implementation of Virtual Three Dimensional Object Display

In some examples, the health data will be received from a sensor and transmitted to a computing device, such as a computer with a memory, database, or other storage device. The health data may then be saved and stored on local memory or saved in a remote database, such as by a server and hard disk. In some examples, a local processor and local memory will store the health data from the patient, and process the health data through the steps to output computer instructions that may be processed by a processor in communication with a display to output a virtual representation of a three dimensional object 20.

In some examples, a server will process the health data and then send instructions over a network to a local device for display to a user. In other examples, the user will download an application with instructions onto a mobile device. The mobile device will then receive data input from another source, such as a user inputting the data (e.g. blood glucose readings) manually or in the alternative a sensor may be in communication with the display device. Accordingly, a blood glucose meter, heart monitor, blood pressure monitor, or other medical device and/or medical sensor may send health data to the computer for consolidation, transformation and display or physical manufacturing.

It should initially be understood that the disclosure herein may be implemented with any type of hardware and/or software, and may be a pre-programmed general purpose computing device. For example, the system may be implemented using a server, a personal computer, a portable computer, a thin client, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer to-peer networks).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a “data processing apparatus” on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

### CONCLUSION

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Certain embodiments of this application are described herein. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

Particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A method for visualizing data as a three dimensional object, the method comprising:
collecting a set of data points representing a plurality of measurements of at least one health data variable over a period of time from a patient;
calculating a statistical value of the set of data points;
building a three-dimensional object that has at least one proportion or dimension of the three dimensional object based on the statistical value; and
building at least one protrusion on the three dimensional object, wherein a dimension of each of the at least one protrusions is based on a subset of the set of data points.

2. The method of claim 1 wherein the three dimensional object is a sphere and the protrusions are conical shaped.

3. The method of claim 1 wherein the statistical value is an average value.

4. The method of claim 1 wherein the dimension of the protrusion is height, and the height of each protrusion is proportional to an average value of the subset of the set of data points.

5. The method of claim 4, wherein the subset of data points is a single data point.

6. The method of claim 4, wherein the larger the average value the larger the height of each protrusion.

7. The method of claim 4, wherein the height is positive if the average value is over a threshold value, and wherein the height is negative and the protrusion becomes a valley inside the three dimensional object if the average value is below a threshold value.

8. The method of claim 1 wherein the three dimensional object is green when the average value is within a normal range for the health-affecting variable being measured, yellow when the average value is moderately above the normal range, and red when the average value is significantly below or above the normal range.

9. The method of claim 1 wherein the three dimensional object is green when the average value of the at least one health-affecting variable is within a normal range for the health-affecting variable being measured, red when the average significantly value is above the normal range, and yellow when the average value is moderately above or below the normal range.

10. The method of claim 1 wherein the shape and color of the three dimensional object is chosen by a user.

11. The method of claim 1 wherein the three dimensional object is made from a material selected from the group consisting of polymer, wood, metal, ceramic, glass, fabric, and combinations thereof.

12. The method of claim 1 wherein the three dimensional object is made through a process selected from the group consisting of 3-D printing, die-cast molding, injection molding, laser cutting, carving, sewing and combinations thereof.

13. The method of claim 7, wherein the threshold is selected from the group consisting of: blood glucose between a range, or blood glucose above or below a percentile.

14. A system for displaying a three dimensional object representing health data of a patient, the system comprising:
a display;
a memory containing machine readable medium comprising machine executable code having stored thereon instructions for performing a method of display a virtual representation of a three dimensional object;
a control system coupled to the memory, the control system configured to execute the machine executable code to cause the control system to:
receive, at the control system, a set of data points representing a plurality of measurements of at least one health data variable over a period of time from a patient;
determine, by the control system, a statistical value of the set of data points;
build, by the control system, a three-dimensional object that has at least one proportion or dimension of the three dimensional object based on the statistical value;
build, by the control system, at least one protrusion on the three dimensional object, wherein a dimension of each of the at least one protrusions is based on a subset of the set of data points; and
display the three dimensional object with the at least one protrusion on the display.

15. The system of claim 14, wherein the system is a mobile device.

16. The system of claim 14, wherein the time period is divided into a set of shorter time periods with a separate subset of data points falling into each shorter time period, and the control system determines the average value of each separate subset of data points.

17. The system of claim 16, wherein the three dimensional object includes a physical feature of each shorter time period that has a dimension that is based on the average value of its corresponding separate subset of data points.

18. The system of claim 17, wherein the dimension is a diameter, or width of the three dimensional object.

19. The system of claim 18, wherein the set of shorter time periods are four time periods, and the physical feature is symmetrical spaced around the three dimensional object.

20. The system of claim 19, wherein the physical feature are planar like surfaces of the three dimensional object.

21. The system of claim 14, wherein the health data is sent through an API to the control system and saved locally on the memory by the control system.

22. The system of claim 14, wherein the system further comprises a blood glucose monitor in communication with the control system.

23. The system of claim 14, wherein the control system sends instructions to a 3D printer to print a physical representation of the three dimensional object.
